(19) United States
(12) Patent Application Publication
(10) Pub. No.: US 2003/0027871 A1
(43) Pub. Date: Feb. 6, 2003

(54) Process for the manufacture of colloidal particles of controlled shape with water-soluble block copolymers comprising a hydrophobic block and a hydrophilic block

(76) Inventors: Denis Bendejacq, Cranbury, NJ (US); Mathieu Joanicot, Lawrenceville, NJ (US); Virginie Ponsinet, New York, NY (US)

Correspondence Address: RHODIA INC., 259 Prospect Plains Road, Bldg. N-2, CRANBURY, NJ, 08512-7500, US

(21) Appl. No.: 10/101,884

(22) Filed: Mar. 20, 2002

Related U.S. Application Data
(60) Provisional application No. 60/278,035, filed on Mar. 22, 2001.

(51) Int. Cl. C09K 3/00; B01F 3/12; B01F 17/00

(52) U.S. Cl. 516/77

(57) ABSTRACT

The invention relates to a process for the manufacture of colloidal particles of controlled shape, controlled size and controlled anisotropy with water-soluble block copolymer comprising at least one block of hydrophobic nature and at least one block of hydrophilic nature which can exhibit bulk organized structures and which can retain the morphology of the hydrophobic aggregates during dispersion in water. These aggregate dispersions can be used as thickening agents or as texturing agents for paints.

This application claims priority under 35 U.S.C. §§119 and/or 365 to 60/278,035 filed in the United States on Mar. 22 2001.

The present invention relates to a novel process for the manufacture of colloidal particles with controlled shapes with water-soluble block polymers comprising a hydrophobic block and a hydrophilic block which can exhibit bulk organized structures.

Numerous studies have been carried out on block polymers. These studies generally relate to organic solvent media, more rarely to aqueous media. It has been found that numerous morphologies can be obtained (spheres, rods, strips) with block polymers in an organic medium. However, in an aqueous medium, the only amphiphilic block polymers which known as exhibiting anisotropic structures at equilibrium are polymers exhibiting a hydrophobic block and a water-soluble neutral block, for example polyethylene (PEE)-b-poly(ethylene oxide) (PEO) diblocks. These systems are such that the hydrophobic block has a glass transition temperature below ambient temperature.

Some studies have been carried out on amphiphilic block polymers exhibiting a hydrophobic block and an anionic hydrophilic block. These polymers have been studied in dispersion in water only when the anionic hydrophilic block is very large in weight in comparison with the hydrophobic block and it has been shown that they then exist in the form of spherical micelles (star-like micelles). Anisotropic morphologies can be obtained with these polymers for diblocks exhibiting a long hydrophobic block and a short anionic block, provided that they are first of all dissolved under dilute conditions in an organic solvent phase before being introduced into the aqueous medium. However, these anisotropic structures are highly dependent on the preparation conditions and have not been proved to be controllable to date.

One of the aims of the present invention is specifically to provide a process for the manufacture of anisotropic particles of the above type, the size and the shape of which can be controlled, which can be prepared from block copolymers of high dispersity.

Another aim of the present invention is to provide a process of the above type where the control of the particles can be brought about by a blend of block copolymer or of a blend of block copolymer and of homopolymers.

This aim and others are achieved by the present invention as the latter relates to a process for the preparation of colloidal particles of controlled shape, controlled size and controlled anisotropy in aqueous dispersion starting from a block copolymer comprising at least one block of hydrophobic nature and at least one block of hydrophilic nature in solution and/or in dispersion in water comprising the following stages:

1) the water is removed from the starting solution and/or dispersion of copolymer to produce the copolymer in the solid form, generally in the form of a powder,

2) the copolymer in the solid form is dissolved in an organic solvent,

3) the solvent is removed to produce a solid, and

4) the solid obtained in 3) is redispersed in water to produce a dispersion of colloidal particles of controlled shape, controlled size and controlled anisotropy, the small dimension of which is generally between 10 and 100 nm.

The removal of the water during stage 1) is carried out by any means, such as evaporation, lyophilization or spray drying.

The particles obtained in stage 4) have various shapes, such as spheres, cylinders, tori or plates. The large dimension of the particles is generally at least 500 nm with a very high upper limit which can be of the order of an mm. The size and the shape of the objects is generally independent of the amount of water added and it is more particularly defined by the copolymer/solvent pair, the nature of the blend of copolymers with optionally homopolymers, the nature of the constituent monomers of the copolymer and the ratio by mass of the hydrophilic blocks to the hydrophobic blocks.

The solvent used during stage 2) is a solvent of the copolymer and is preferably polar. Dimethylformamide or tetrahydrofuran can generally be used. Thus, tetrahydrofuran is recommended for a polystyrene/poly(acrylic acid) copolymer. During stage 3), the solvent is removed, so as to produce a solid exhibiting a microseparation of phase having a characteristic size, the hydrophobic regions being organized in a hydrophilic matrix. The solvent of stage 3) is preferably removed slowly over a period of time of between 0.5 and 72 hours.

According to an alternative form of the process of the invention, the copolymers can be prepared directly in the solvent used in stage 2). In this case, stages 1) and 2) are dispensed with and it is sufficient to carry out stage 3) on the organic solution of the starting copolymers, to produce a solid, and stage 4) on the said solid, to produce the colloidal particles.

Furthermore, and generally, a single copolymer can be used as starting material. However, it is also possible to use, as starting material, a blend of different copolymers and blend of different copolymers or of a copolymer with at least one homopolymer, the said homopolymer exhibiting a single block which is hydrophilic or hydrophobic overall.

The glass transition temperature of the hydrophobic block or blocks of the copolymer is greater than the temperature at which the dispersion is produced in stage 4).

Thus, the block or blocks of hydrophobic nature exhibits a glass transition temperature of greater than 10 degrees Celsius, preferably of greater than 30 degrees Celsius, more preferably still of greater than 60 degrees Celsius.

In addition, the block copolymer preferably exhibits a polydispersity index of between 1.01 and 5.00, more preferably of between 1.01 and 3.50, and a molar mass of at least 4,000 g/mol.

According to the present invention, the term “block of hydrophobic nature” is understood to mean a water-insoluble hydrophobic polymer block which can comprise hydrophilic units in an amount of between 0 and 50%, for example between 1 and 20%, with respect to the total mass of the block. The term “unit” is understood to mean the part of the block corresponding to one monomer unit.

Likewise, the term “block of hydrophilic nature” is understood to mean a water-soluble polymer block comprising hydrophilic units which exhibits from 0 to 50%, for example between 1 and 20%, by weight of hydrophobic units with respect to the total mass of the block.

The properties of the copolymers according to the present invention can be controlled by the choice of the nature of the hydrophobic blocks and of the nature of the hydrophilic blocks and of their respective lengths, and optionally the choice of the blend of copolymers and homopolymers.

According to a first alternative form, the blocks of hydrophobic nature and the blocks of hydrophilic nature can result from the copolymerization of hydrophobic and hydrophilic monomers. The amounts of hydrophilic and hydrophobic units in each of the said blocks are then controlled by the respective contents of hydrophilic monomers and of hydrophobic monomers during the polymerization of the blocks.

Thus, the blocks of hydrophobic nature can result from the copolymerization of hydrophobic monomers and hydrophilic monomers, the hydrophilic monomers being present in an amount of between 0 and 50% by weight with respect to the total mass of the block.

Likewise, the blocks of hydrophilic nature can result from the copolymerization of hydrophilic monomers and optionally of hydrophobic monomers, the hydrophobic monomers being present in an amount of less than 50% by weight with [lacuna] to the total mass of the block.

According to a second alternative form, the blocks of hydrophobic nature and the blocks of hydrophilic nature of the preceding copolymers can result:

from the polymerization of monomers which can be rendered hydrophilic by hydrolysis and optionally of non-hydrolysable hydrophobic monomers and/or of hydrophilic monomers,

and then from the hydrolysis of the polymer obtained.

During the hydrolysis, the units corresponding to the hydrolysable monomers are hydrolysed to hydrophilic units.

The amounts of hydrophilic and hydrophobic units in each of the said blocks are then controlled by the amount of each type of monomers and by the degree of hydrolysis.

According to this second alternative form, various implementations can be envisaged.

According to a first implementation, the blocks can be obtained by:

homopolymerization of hydrophobic monomers which can be rendered hydrophilic by hydrolysis, and

partial hydrolysis of the homopolymer obtained.

According to a second implementation, the blocks can be obtained by:

copolymerization of hydrophobic monomers which can be rendered hydrophilic by hydrolysis and of hydrophobic monomers which cannot be rendered hydrophilic by hydrolysis, then

complete or partial hydrolysis of the polymer obtained.

According to this second implementation, the amount of hydrophilic and hydrophobic units can depend on two criteria: the contents of the various types of monomers and the degree of hydrolysis.

According to a third implementation, the blocks can be obtained by:

copolymerization of hydrophobic monomers which can be rendered hydrophilic by hydrolysis and of hydrophilic monomers, then

partial hydrolysis of the polymer obtained to a degree such that:

either, in the case of the blocks of hydrophobic nature, an amount of hydrophilic units of between 0 and 50% with respect to the total mass of the block is obtained,

or, in the case of blocks of hydrophilic nature, an amount of hydrophobic units of less than 50% by weight with respect to the total mass of the block is obtained.

Generally, the hydrophobic monomers can be chosen from:

vinylaromatic monomers, such as styrene,

dienes, such as butadiene,

alkyl acrylates and methacrylates, the alkyl group of which comprises from 1 to 10 carbon atoms, such as methyl, ethyl, n-butyl, 2-ethylhexyl, t-butyl, isobornyl, phenyl or benzyl acrylates and methacrylates.

It is preferably styrene.

The hydrophilic monomers can be chosen from:

carboxylic acids comprising ethylenic unsaturation, such as acrylic and methacrylic acids,

neutral hydrophilic monomers, such as acrylamide and its derivatives (n-methylacrylamide or n-isopropyl-acrylamide), methacrylamide or poly(ethylene glycol) methacrylate and acrylate,

anionic hydrophilic monomers: sodium 2-acrylamido-2-methylpropanesulphonate (AMPS), sodium styrene-sulphonate or sodium vinylsulphonate.

The monomers which can be rendered hydrophilic by hydrolysis can be chosen from:

acrylic and methacrylic esters which can be hydrolysed to acid, such as methyl acrylate, ethyl acrylate, hydroxyethyl methacrylate, hydroxyethyl acrylate or tert-butyl acrylate,

vinyl acetate which can be hydrolysed to vinyl alcohol units,

quaternized 2-dimethylaminoethyl methacrylate and acrylate (madamquat and adamquat),

acrylamide and (meth)acrylamide.

The block copolymers according to the invention are preferably diblock copolymers.

However, they can also be triblock or indeed even multiblock copolymers. If the copolymer comprises three blocks, it is preferable to have a block of hydrophobic nature flanked by two blocks of hydrophilic nature.

According to the preferred form of the invention, the copolymer is a diblock copolymer comprising a block of hydrophilic nature and a block of hydrophobic nature, in which:

the block of hydrophilic nature comprises acrylic acid (AA) units and ethyl acrylate (EtA) units,

and the block of hydrophobic nature comprises styrene (St) and methacrylic acid (MAA) and/or hydroxyethyl methacrylate (HEMA) units.

Preferably, according to this form, the block of hydrophilic nature results:

from the polymerization of methacrylic acid (MA) and of ethyl acrylate (EthA) in an EtA/MA ratio by weight of 70/5,

and then from the hydrolysis of the polymer obtained to a degree of at least 95 mol %.

The block of hydrophobic nature itself preferably results from the polymerization of a mixture of monomers comprising at least 60% by weight of styrene.

The block polymers used in the process according to the invention generally exhibit a molecular mass of at most 100,000 g/mol, preferably of at least 4,000 g/mol.

Generally, the preceding block copolymers can be obtained by any polymerization process referred to as living or controlled, such as, for example:

radical polymerization controlled by xanthates, according to the teaching of Application WO 98/58974,

radical polymerization controlled by dithioesters, according to the teaching of Application WO 97/01478,

polymerization using nitroxide precursors, according to the teaching of Application WO 99/03894,

radical polymerization controlled by dithiocarbamates, according to the teaching of Application WO 99/31144,

atom transfer radical polymerization (ATRP), according to the teaching of Application WO 96/30421,

radical polymerization controlled in particular by xanthates, for the purpose of preparing predominantly hydrophilic and predominantly hydrophobic block copolymers,

radical polymerization controlled by iniferters, according to the teaching of Otu et al., Makromol. Chem. Rapid. Commun., 3, 127 (1982),

radical polymerization controlled by iodine degenerative transfer, according to the teaching of Tatemoto et al., Jap., 50, 127, 991 (1975), Daikin Kogyo Co. Ltd. Japan and Matyjaszewski et al., Macromolecules, 28, 2093 (1995)),

group transfer polymerization, according to the teaching of Webster O. W., “Group Transfer Polymerization”, p. 580-588 of the “Encyclopedia of Polymer Science and Engineering”, vol. 7 and edited by H. F. Mark, N. M. Bikales, C. G. Overberger and G. Menges, Wiley Interscience, New York, 1987,

radical polymerization controlled by tetraphenylethane derivatives (D. Braun et al., Macromol. Symp., 111, 63 (1996)),

radical polymerization controlled by organocobalt complexes (Wayland et al., J. Am. Chem. Soc., 116, 7973 (1994)).

The preferred polymerization is living radical polymerization using xanthates.

The invention thus additionally relates to a process for the preparation of these block polymers.

This process consists in:

1bringing into contact:

at least one ethylenically unsaturated monomer,

at least one source of free radicals, and

at least one compound of formula (I):

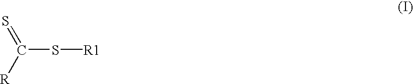

in which:

R represents an R20-, R2R′2N- or R3- group, with: R2 and R′2, which are identical or different, representing (i) an alkyl, acyl, aryl, alkene or alkyne group or (ii) an optionally aromatic, saturated or unsaturated carbonaceous ring or (iii) a saturated or unsaturated heterocycle, it being possible for these groups and rings (i), (ii) and (iii) to be substituted, R3 representing H, Cl, an alkyl, aryl, alkene or alkyne group, a saturated or unsaturated (hetero)cycle, these optionally being substituted, an alkylthio, alkoxycarbonyl, aryloxycarbonyl, carboxyl, acyloxy, carbamoyl, cyano, dialkyl- or diarylphosphonato or dialkyl- or diarylphosphinato group or a polymer chain,

R1 represents (i) an optionally substituted alkyl, acyl, aryl, alkene or alkyne group or (ii) an optionally substituted or aromatic, saturated or unsaturated carbonaceous ring or (iii) an optionally substituted, saturated or unsaturated heterocycle, or a polymer chain, 2- repeating the preceding contacting operation at least once using:

different monomers from the preceding implementation, and

in place of the precursor compound of formula (I), the polymer resulting from the preceding implementation, 3- optionally hydrolysing the copolymer obtained.

The R1, R2, R′2 and R3 groups can be substituted by alkyl groups, phenyl groups, which are substituted, substituted aromatic groups, oxo, alkoxycarbonyl or aryloxycarbonyl (—COOR), carboxyl (—COOH), acyloxy (—O2CR), carbamoyl (—CONR2), cyano (—CN), alkylcarbonyl, alkylarylcarbonyl, arylcarbonyl, arylalkylcarbonyl, isocyanate, phthalimido, maleimido, succinimido, amidino, guanidimo, hydroxyl (—OH), amino (—NR2), halogen, allyl, epoxy, alkoxy (—OR), S-alkyl, S-aryl or silyl groups, or groups exhibiting a hydrophilic or ionic nature, such as alkaline salts of carboxylic acids, alkaline salts of sulphonic acid, poly(alkylene oxide) (PEO, PPO) chains or cationic substituents (quaternary ammonium salts), R representing an alkyl or aryl group.

The compound of formula (I) is preferably a dithiocarbonate chosen from the compounds of following formulae (IA), (IB) and (IC):

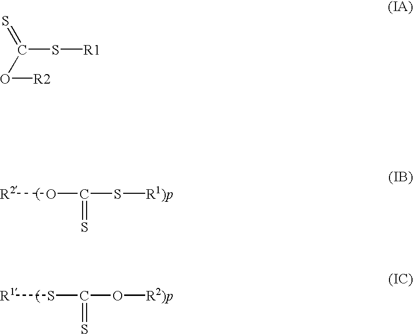

in which:

R2 and R2′ represent (i) an alkyl, acyl, aryl, alkene or alkyne group or (ii) an optionally aromatic, saturated or unsaturated carbonaceous ring or (iii) a saturated or unsaturated heterocycle, it being possible for these groups and rings (i), (ii) and (iii) to be substituted,

R1and R1′ represent (i) an optionally substituted alkyl, acyl, aryl, alkene or alkyne group or (ii) an optionally substituted or aromatic, saturated or unsaturated carbonaceous ring or (iii) an optionally substituted, saturated or unsaturated heterocycle, or a polymer chain,

p is between 2 and 10.

During stage 1, a first block of the polymer of hydrophilic or hydrophobic nature, according to the nature and the amount of monomers used, is synthesized. During stage 2, the other block of the polymer is synthesized.

The ethylenically unsaturated monomers will be chosen from the hydrophilic, hydrophobic and hydrolysable monomers defined above in proportions suitable for obtaining a block copolymer with blocks exhibiting the characteristics of the invention. According to this process, if all the successive polymerizations are carried out in the same reactor, it is generally preferable for all the monomers used during one stage to be consumed before the polymerization of the following stage begins, thus before the new monomers are introduced. However, it may happen that the hydrophobic or hydrophilic monomers of the preceding stage are still present in the reactor during the polymerization of the following block. In this case, these monomers generally do not represent more than 5 mol % of all the monomers and they participate in the following polymerization by contributing to the introduction of the hydrophobic or hydrophilic units into the following block.

For further details with regard to the preceding polymerization process, reference may be made to the content of Application WO 98/58974.

The optional hydrolysis can be carried out using a base or an acid. The base can be chosen from alkali metal or alkaline earth metal hydroxides, such as sodium hydroxide or potassium hydroxide, alkali metal alkoxides, such as sodium methoxide, sodium ethoxide, potassium methoxide, potassium ethoxide or potassium t-butoxide, ammonia and amines, such as triethylamines. The acids can be chosen from sulphuric acid, hydrochloric acid or para-toluenesulphonic acid. Use may also be made of an ion-exchange resin or an ion-exchange membrane of cationic or anionic type. The hydrolysis is generally carried out at a temperature of between 5 and 100° C., preferably between 15 and 90° C.

Preferably, after hydrolysis, the block copolymer is washed, for example by dialysis against water or using a solvent, such as alcohol. It can also be precipitated by lowering the pH below 4.5.

The hydrolysis can be carried out on a single-block polymer, which will subsequently be associated with other blocks, or on the final block polymer.

Finally, the invention relates to the use of the preceding block copolymers as texture modifiers or thickening agents for paint and latex dispersions. The polymers should preferably be used in an amount of at least 0.5% and of at most 5% by weight with respect to the aqueous medium to be treated.

At low concentration and depending upon the shape of the objects, the aqueous dispersions according to the invention can constitute newtonian or non-newtonian systems. The non-newtonian systems, for example aqueous dispersions for which the concentration by weight of particles, preferably cylindrical in shape, is greater than approximately 1% and generally less than 20%, can be used as lubricant or heat-thickening agent or as lubricant additive. The block copolymers according to the invention exhibit in particular the advantage of rendering the Theological properties of an aqueous solution or dispersion variable with the temperature. Thus the invention also relates to a process for heat-thickening a composition, comprising using dispersions prepared by a process according to the invention, for which the concentration by weight of particles, preferably cylindrical in shape, is greater than approximately 1% and generally less than 20%.

Thus, aqueous dispersions comprising colloidal particles of controlled shape, controlled size or controlled anisotropy, at a concentration comprised between 0.5 and 5% by weight, may be used as surface treatment agent, for solid surfaces. More particularly, they may be used for lubricating solid surfaces. Thus, the invention also relates to a process for treating surfaces, for example for lubricating a solid surface, comprising the step of applying onto the surface an aqueous dispersions comprising colloidal particles of controlled shape, controlled size or controlled anisotropy, at a concentration comprised between 0.5 and 5% by weight.

The following examples illustrate the invention without, however, limiting the scope thereof.

In the examples which follow:

Mn represents the number-average molecular mass of the polymers,

Mw represents the weight-average molecular mass,

Mw/Mn represents the polydispersity index, the polymers, before hydrolysis, are analysed by GPC with polystyrene calibration and with THF as elution solvent.

### Example I: SERIES OF PS-PAA DIBLOCKS (poly(styrene)-b-poly(ethyl acrylate/methacrylic acid) 2k-14k; 3k-13k; 4.3k-11.7k and 8k-8k:

TABLE 1
Characteristics of the samples from
the examples:

| | Sample | Styrene | |
|---|---|---|---|
| Diblock copolymers^{a} | Number | ratio^{b} | Ip^{c} (GPC) |
| [Sty]₂₀-b-[AA]₂₀₀ | (01) | 0.120 | 2.1 |
| [Sty]₃₀-b-[AA]₁₈₀ | (02) | 0.186 | 2.4 |
| [Sty]₄₄-b-[AA]₁₆₂ | (03) | 0.271 | 2.6 |
| [Sty]₈₃-b-[AA]₁₂₃ | (04) | 0.481 | 2.2 |
| [Sty]₁₂₅-b-[AA]₂₃ | (07) | 0.884 | 2.1 |

In the above Table I, the indices show the number of monomers in each block, determined from the GPC and NMR data (including in each block the methacrylic acid comonomer introduced in a proportion of between 2 and 5% of the total weight of the diblock, to facilitate synthesis). b: ratio by mass of polystyrene. c: polydispersity index Ip=Mw/Mn, measured by GPC.

A—SYNTHESIS AND HYDROLYSIS

### I-Diblock (01)

### 1.1. Synthesis of a Styrene Polymer

The polymerization is carried out under emulsion conditions in a jacketed reactor equipped with a stainless steel three-bladed stirrer. 416.17 g of water, 10.76 g of dodecyl sulphate (Texapon K12/96), 0.35 g of sodium hydrocarbonate NaHCO₃ and 2.02 g of styrene are introduced at ambient temperature as vessel heel. The mixture obtained is stirred for 15 minutes (175 rev/min) under nitrogen. The temperature is subsequently raised to 85° C. and then a mixture comprising 0.44 g of ammonium persuiphate (NH₄)₂S₂O₈ and 2.1 g of methyl 2-(ethoxythiocarbonylsulphanyl)-propionate (CH3CH(CO2CH3)S(CS)OEt) in 3.50 g of water is incorporated. Simultaneously, the addition of 18.18 g of styrene is begun. The addition lasts 45 minutes. After complete addition, an emulsion polymer (latex) is obtained and is maintained at 85° C. for one hour. After cooling to ambient temperature, 194.4 g of the polymer emulsion are withdrawn.

Analysis of this first sample by chromatography gives the following results:

Mₙ=2 040 g/mol

M_{w}/Mₙ=2.0

### I.2. Synthesis of the Diblock Copolymer

The starting material is the remainder of the emulsified copolymer obtained above (§2.1.). 0.125 g of ammonium persulphate (NH₄)₂S₂O₈ in 2.05 g of water is added to it at 85° C. Simultaneously, the addition is begun of a mixture composed of:

105.9 g of ethyl acrylate (EtA),

5.57 g of methacrylic acid (MAA), and

0.32 g of Na₂CO₃ diluted in 32 g of water.

The addition lasts 1 hour. The system is maintained at this temperature for an additional hour.

After cooling to ambient temperature, the polymer obtained is analysed. The chromatographic analysis results (with polystyrene calibration) are as follows:

Mₙ=26 000 g/mol

M_{w}/Mₙ=2.1

### I.3. Hydrolysis of the Diblock Copolymer

The hydrolysis is carried out in the reactor used for the synthesis of the block copolymer emulsion The following are introduced therein:

32 g of the preceding copolymer (§1.2.), expressed on a dry basis (100 g at 32%),

311 g of water (to adjust the solids content to 4% by weight at the end of hydrolysis).

The temperature is brought to 90° C. and the emulsion is stirred vigorously (160 rev/min) for one hour. 389 g of 2N sodium hydroxide solution (corresponding to two molar equivalents of sodium hydroxide with respect to the ethyl acrylate) are added over two hours. After complete addition of the sodium hydroxide, the temperature is brought to 95° C. and the reaction is maintained under these conditions for 48 hours.

The degree of hydrolysis of the acrylate units is measured by proton NMR to be 98 mol %.

The product recovered at the end of the reaction is a translucent gel. 150 g of this gel are mixed with a mixture of 400 g of 37.5% aqueous HCl solution and 150 g of water.

II—Synthesis and Hydrolysis of the Diblock (02)

### II.1. Synthesis of a Styrene Polymer

The polymerization is carried out under emulsion conditions in a jacketed reactor equipped with a stainless steel three-bladed stirrer. 406 g of water, 10.6 g of dodecyl sulphate (Texapon K12/96), 0.35 g of sodium hydrocarbonate NaHCO₃ and 2.9 g of styrene are introduced at ambient temperature as vessel heel. The mixture obtained is stirred for 15 minutes (175 rev/min) under nitrogen. The temperature is subsequently raised to 85° C. and then a mixture comprising 0.44 g of ammonium persulphate (NH₄)₂S₂O₈ and 2.1 g of methyl 2-(ethoxythiocarbonylsulphanyl)-propionate (CH3CH(CO2CH3)S(CS)OEt) in 3.5 g of water is incorporated. Simultaneously, the addition of 26.4 g of styrene is begun. The addition lasts 45 minutes. After complete addition, an emulsion polymer (latex) is obtained and is maintained at 85° C. for one hour. After cooling to ambient temperature, 193.9 g of the polymer emulsion are withdrawn.

Analysis of this first sample by chromatography gives the following results:

Mₙ=3 135 g/mol

M_{w}/Mₙ=1.83

### II.2. Synthesis of the Diblock Copolymer

The starting material is the remainder of the emulsified copolymer obtained above (§II.1.). 0.125 g of ammonium persulphate (NH₄)₂S₂O₈ in 2.0 g of water is added to it at 85° C. Simultaneously, the addition is begun of a mixture composed of:

99.73 g of ethyl acrylate (EtA),

5.25 g of methacrylic acid (MAA), and

0.32 g of Na₂CO₃ diluted in 52.7 g of water.

The addition lasts 1 hour. The system is maintained at this temperature for an additional hour.

After cooling to ambient temperature, the polymer obtained is analysed. The chromatographic analysis results are as follows:

Mₙ=17 275 g/mol

M_{w}/Mₙ=2.4

### II.3. Hydrolysis of the Diblock Copolymer

The hydrolysis is carried out in the reactor used for the synthesis of the block copolymer emulsion. The following are introduced therein:

29 g of the preceding copolymer (§1.2.), expressed on a dry basis (100 g at 29%),

298 g of water (to adjust the solids content to 4% by weight at the end of hydrolysis).

The temperature is brought to 90° C. and the emulsion is stirred vigorously (160 rev/min) for one hour. 327 g of 2N sodium hydroxide solution (corresponding to two molar equivalents of sodium hydroxide with respect to the ethyl acrylate) are added over two hours. After complete addition of the sodium hydroxide, the temperature is brought to 95° C. and the reaction is maintained under these conditions for 48 hours.

The degree of hydrolysis of the acrylate units is measured by proton NMR to be 98 mol %.

The product recovered at the end of the reaction is a translucent gel. 150 g of this gel are mixed with a mixture of 400 g of 37.5% aqueous HCl solution and 200 g of water.

III—Synthesis and Hydrolysis of the Diblock (03)

### III.1. Synthesis of a Styrene Polymer

The polymerization is carried out under emulsion conditions in a jacketed reactor equipped with a stainless steel three-bladed stirrer. 401 g of water, 10.3 g of dodecyl sulphate (Texapon K12/96), 0.35 g of sodium hydrocarbonate NaHCO₃ and 4.3 g of styrene are introduced at ambient temperature as vessel heel. The mixture obtained is stirred for 15 minutes (175 rev/min) under nitrogen. The temperature is subsequently raised to 85° C. and then a mixture comprising 0.44 g of ammonium persulphate (NH₄)₂S₂O₈ and 2.1 g of methyl 2-(ethoxythiocarbonylsulphanyl)-propionate (CH3CH(CO2CH3)S(CS)OEt) in 3.5 g of water is incorporated. Simultaneously, the addition of 38.7 g of styrene is begun. The addition lasts 45 minutes. After complete addition, an emulsion polymer (latex) is obtained and is maintained at 85° C. for one hour. After cooling to ambient temperature, 197.4 g of the polymer emulsion are withdrawn.

Analysis of this first sample by chromatography gives the following results:

Mₙ=4 560 g/mol

M_{w}/Mₙ=1.77

### III.2. Synthesis of the Diblock Copolymer

The starting material is the remainder of the emulsified copolymer obtained above (§II.1.). 0.125 g of ammonium persulphate (NH₄)₂S₂O₈ in 2.0 g of water is added to it at 85° C. Simultaneously, the addition is begun of a mixture composed of:

89.1 g of ethyl acrylate (EtA),

4.7 g of methacrylic acid (MAA), and

0.27 g of Na₂CO₃ diluted in 47.7 g of water.

The addition lasts 1 hour. The system is maintained at this temperature for an additional hour.

After cooling to ambient temperature, the polymer obtained is analysed. The chromatographic analysis results are as follows:

Mₙ=16 150 g/mol

M_{w}/Mₙ=2.61

### III.3. Hydrolysis of the Diblock Copolymer

The hydrolysis is carried out in the reactor used for the synthesis of the block copolymer emulsion. The following are introduced therein:

30 g of the preceding copolymer (§1.2.), expressed on a dry basis (100 g at 30%),

350 g of water (to adjust the solids content to 4% by weight at the end of hydrolysis).

The temperature is brought to 90° C. and the emulsion is stirred vigorously (160 rev/min) for one hour. 300 g of 2N sodium hydroxide solution (corresponding to two molar equivalents of sodium hydroxide with respect to the ethyl acrylate) are added over two hours. After complete addition of the sodium hydroxide, the temperature is brought to 95° C. and the reaction is maintained under these conditions for 48 hours.

The degree of hydrolysis of the acrylate units is measured by proton NMR to be 98 mol %.

The product recovered at the end of the reaction is a translucent gel. 150 g of this gel are mixed with a mixture of 400 g of 37.5% aqueous HCl solution and 250 g of water. The precipitate is washed with a 2N HCl solution.

IV—Synthesis and Hydrolysis of the Diblock (04)

### IV.1. Synthesis of a Styrene Polymer

The polymerization is carried out under emulsion conditions in a jacketed reactor equipped with a stainless steel three-bladed stirrer. 390.25 g of water, 9.61 g of dodecyl sulphate (Texapon K12/96), 0.35 g of sodium hydrocarbonate NaHCO₃ and 8.08 g of styrene are introduced at ambient temperature as vessel heel. The mixture obtained is stirred for 15 minutes (175 rev/min) under nitrogen. The temperature is subsequently raised to 85° C. and then a mixture comprising 0.43 g of ammonium persulphate (NH₄)₂S₂O₈ and 2.1 g of methyl 2-(ethoxythiocarbonylsulphanyl)-propionate (CH3CH(CO2CH3)S(CS)OEt) in 3.50 g of water is incorporated. Simultaneously, the addition of 72.70 g of styrene is begun. The addition lasts 45 minutes. After complete addition, an emulsion polymer (latex) is obtained and is maintained at 85° C. for one hour. After cooling to ambient temperature, 207.7 g of the polymer emulsion are withdrawn.

Analysis of this first sample by chromatography gives the following results:

Mₙ=8 673 g/mol

M_{w}/Mₙ=2.16

### IV.2. Synthesis of the Diblock Copolymer

The starting material is the remainder of the emulsified copolymer obtained above (§2.1.). 0.25 g of ammonium persulphate (NH₄)₂S₂O₈ in 4.10 g of water is added to it at 85° C. Simultaneously, the addition is begun of a mixture composed of:

60.52 g of ethyl acrylate (EtA),

3.19 g of methacrylic acid (MAA), and

0.18 g of Na₂CO₃ diluted in 19.79 g of water.

The addition lasts 1 hour. The system is maintained at this temperature for an additional hour.

After cooling to ambient temperature, the polymer obtained is analysed. The chromatographic analysis results are as follows:

Mₙ=18 218 g/mol

M_{w}/Mₙ=2.18

### IV.3. Hydrolysis of the Diblock Copolymer

The hydrolysis is carried out in the reactor used for the synthesis of the block copolymer emulsion. The following are introduced therein:

31.33 g of the preceding copolymer (§1.2.), expressed on a dry basis (100 g at 31.33%),

480 g of water (to adjust the solids content to 4% by weight at the end of hydrolysis).

The temperature is brought to 90° C. and the emulsion is stirred vigorously (160 rev/min) for one hour. 197 g of 2N sodium hydroxide solution (corresponding to two molar equivalents of sodium hydroxide with respect to the ethyl acrylate) are added over two hours. After complete addition of the sodium hydroxide, the temperature is brought to 95° C. and the reaction is maintained under these conditions for 136 hours.

The degree of hydrolysis of the acrylate units is measured by proton NMR to be 98 mol %.

The product recovered at the end of the reaction is a translucent gel. 150 g of this gel are mixed with 1 700 g of water. The solution obtained is precipitated from a mixture of 411 g of 37.5% aqueous HCl solution and 150 g of water. The precipitate is washed with a 2N HCl solution.

V—Synthesis and Hydrolysis of the Diblock (07):

### V.I. Synthesis of a Styrene Polymer

The polymerization is carried out under emulsion conditions in a jacketed reactor equipped with a stainless steel three-bladed stirrer. 365.2 g of water, 8.4 g of dodecyl sulphate (Texapon K12/96), 0.35 g of sodium hydrocarbonate NaHCO₃ and 14.12 g of styrene are introduced at ambient temperature as vessel heel. The mixture obtained is stirred for 15 minutes (175 rev/min) under nitrogen. The temperature is subsequently raised to 85° C. and then a mixture comprising 0.44 g of ammonium persulphate (NH₄)₂S₂O₈ and 2.1 g of methyl 2-(ethoxythiocarbonylsulphanyl)-propionate (CH3CH(CO2CH3)S(CS)OEt) in 3.5 g of water is incorporated. Simultaneously, the addition of 127.22 g of styrene is begun. The addition lasts 45 minutes. After complete addition, an emulsion polymer (latex) is obtained and is maintained at 85° C. for one hour. After cooling to ambient temperature, 223.5 g of the polymer emulsion are withdrawn.

Analysis of this first sample by chromatography gives the following results:

Mₙ=12 973 g/mol

M_{w}/Mₙ=2.21

### V.2. Synthesis of the Diblock Copolymer

The starting material is the remainder of the emulsified copolymer obtained above (§II.1.). 0.12 g of ammonium persulphate (NH₄)₂S₂O₈ in 2.0 g of water is added to it at 85° C. Simultaneously, the addition is begun of a mixture composed of:

15.13 g of ethyl acrylate (EtA),

0.8 g of methacrylic acid (MAA), and

0.045 g of Na₂CO₃ diluted in 5.11 g of water.

The addition lasts 1 hour. The system is maintained at this temperature for an additional hour.

After cooling to ambient temperature, the polymer obtained is analysed. The chromatographic analysis results are as follows:

Mₙ=15 890 g/mol

M_{w}/Mₙ=2.13

### V.3. Hydrolysis of the Diblock Copolymer

The hydrolysis is carried out in the reactor used for the synthesis of the block copolymer emulsion. The following are introduced therein:

29 g of the preceding copolymer (§1.2.), expressed on a dry basis (100 g at 29%),

575 g of water (to adjust the solids content to 4% by weight at the end of hydrolysis).

The temperature is brought to 90° C. and the emulsion is stirred vigorously (160 rev/min) for one hour. 50 g of 2N sodium hydroxide solution (corresponding to two molar equivalents of sodium hydroxide with respect to the ethyl acrylate) are added over two hours. After complete addition of the sodium hydroxide, the temperature is brought to 95° C. and the reaction is maintained under these conditions for 48 hours.

The degree of hydrolysis of the acrylate units is measured by proton NMR to be 98 mol %.

B—PROPERTIES OF THE PRECEDING PS-PAA (poly(styrene)-b-poly(ethyl acrylate/methacrylic acid) DIBLOCK COPOLYMERS:

### Preparation of the Dry Films

The products are redispersed in a {water+THF} mixture, 50% v/v THE, and then dialysed against an HCl solution at pH 2.5 with Spectra/Por® membranes (cellulose) with a cut-off of 3 500 for several days. The final dialyses are carried out against deionized water. The solutions are subsequently lyophilized.

The powders obtained are dissolved in tetra-hydrofuran (THF) at a concentration of 15 to 20% by mass, which gives transparent and slightly viscous solutions. It is confirmed that the copolymers are soluble at 1% by mass in THF by quasielastic light scattering experiments. Films are obtained in Teflon moulds by slow evaporation of the THF (3 to 4 days). Their thickness is of the order of 200 to 400 micro-meters.

### Bulk Systems

The structural characteristics of the copolymer in the dry state are presented below.

For all the samples presented in Table I, the small angle X-ray scattering (SAXS) spectra exhibit an intense diffraction peak, which corresponds to the spatial correlation of the phase microseparation. The value of the scattering vector of the maximum, q0, is related to the distance d₀ between the domains by the following formula:

$${q}_{0} = A \times \frac{2 π}{{d}_{0}}$$

where A is a coefficient dependant on the lattice.

For samples (01) and (02), a correlation peak is observed at the positions q₀=0.0250 and q₀=0.0267 Å⁻¹ respectively. It is possible, at the greatest values of the scattering vector, to adjust, over the spectrum, the form factor of a sphere with a radius of respectively 88 Å for (01) and 96 Å for (02). These structures are identified as poorly organized systems of spheres.

For the sample (03), several orders of correlation are observed at the positions q₀=0.0185, q₁=0.0373 and q₂=0.0550 Å⁻¹, that is to say in ratios 1:√4:√7, and thus corresponding to a structure of cylinders exhibiting a hexagonal order.

For the sample (04), several orders of correlation are observed at the positions q₀=0.0245, q₁=0.0486, q₂=0.0665 and q₃0.0741 Å⁻¹, that is to say in ratios 1:2:3:4, and thus corresponding to a lamellar structure.

For the sample (07), the spectrum obtained resembles that of the systems (01) or (02) with a correlation peak at q₀=0.0180 Å⁻¹ and the form factor of a sphere with a radius of 120 Å. The structure is identified as an inverse structure of PAA spheres in a continuous PS matrix.

The structures deduced from the X-ray experiment are confirmed by transmission electro-miscroscopy carried out on a section (microtomy) of the sample.

### Disperse Systems

The bulk systems described above can be dispersed in water, which increases the volume occupied by the hydrophilic block. Since the pSty block is vitreous at ambient temperature, the hydrophobic domains cannot change and retain their morphologies. This is demonstrated by a Small Angle Neutron Scattering (SANS) study. It is found that the dilution of the disperse systems follows the law:

$$\frac{2 π}{{q}_{n}} = n {κφ}^{- 1 / D}$$

wherein

qₙ is the position of the peak of order n,

φ is the fraction by volume of diblock,

K is a prefactor related to the form of the

domains and to the lattice, and

D is the dimensionality of the dilution.

The dilutions laws obtained correspond respectively to dimensionalities of 3, 2 and 1 for (01), (03) and (04) and are thus in agreement with the spherical, cylindrical and lamellar morphologies obtained with the bulk systems (φ=1).

It is interesting to note that the structures retain a long distance order over wide concentration ranges, up to distances between objects of the order of 100 nm.

The dilution of the systems which are described above reaches a limit when the distance between objects becomes of the order of magnitude of the reach of the interactions between them. A macroscopic phase separation is then observed. The objects, the morphology of which is frozen, behave as colloidal particles and not as surfactants, the aggregation morphology of which changes with the concentration.

### Systems at Equilibrium

When the colloidal suspensions described above are heated, the PSty cores are allowed to relax towards their equilibrium morphology.

This is observed, for example, with a 2% by mass suspension of the copolymer (04): when the suspension has not been heated, it is separated into two liquid phases, whereas it becomes a single-phase gel of spheres if it is heated at 100° C. for a few minutes. This transition has been studied in detail by SANS. It can be taken advantage of in a heat-thickening system, that is to say which thickens under the effect of a rise in temperature.

The systems at equilibrium, obtained after heating dilute suspensions, are all composed of spherical micelles composed of a dense PSty cores and of a swollen PAA brush. The radius of the PSty cores and the aggregation number of the micelles were measured by SANS and transition electron microscopy (cryofracture) and the values are collated in Table 2 below:

TABLE 2

| Sample of | | Aggregation |
|---|---|---|
| copolymer | Radius (nm) | number |
| (01) | 5.8 | 230 |
| (02) | 6.7 | 300 |
| (03) | 8.5 | 350 |
| (04) | 13.0 | 700 |

It is seen that the dimension of the micelles and therefore their Theological properties at a given concentration depend on the copolymer chosen.

1. A Process for the manufacture of colloidal particles of controlled shape, controlled size and controlled anisotropy in aqueous dispersion, starting from a block copolymer comprising at least one block of hydrophobic nature and at least one block of hydrophilic nature, in solution or in dispersion in water, comprising the following steps:
step 1) the water is removed from the starting solution or dispersion of copolymer to obtain the copolymer in a solid form,
step 2) the copolymer in the solid form is dissolved in an organic solvent,
step 3) the solvent is removed to produce a solid, and
step 4) the solid obtained in step 3) is redispersed in water to produce a dispersion of colloidal particles of controlled shape, controlled size and controlled anisotropy, said colloidal particles having a small dimension of between 10 and 100 nm.

2. The process according to claim 1, wherein the removal of the water during step 1) is carried out by evaporation, lyophilization or spray drying.

3. The process according to claim 1, wherein the glass transition temperature of the block or blocks of hydrophobic nature is greater than the temperature at which the dispersion is produced in stage 4).

4. The process according to claim 3, wherein the block or blocks of hydrophobic nature exhibits a glass transition temperature of greater than 10 degrees Celsius.

5. The process according to claim 4, wherein the block or blocks of hydrophobic nature exhibits a glass transition temperature of greater than 60 degrees Celsius.

6. The process according to claim 1, wherein the block copolymer exhibits a polydispersity index of between 1.01 and 5.00 and a molar mass of at least 4,000 g/mol.

7. The process according to claim 6, wherein the block copolymer exhibits a polydispersity index of between 1.01 and 3.50.

8. The process according to claim 1, wherein the block or blocks of hydrophobic nature exhibit hydrophilic units, in an amount of between 0% and 50% by weight with respect to the total mass of the block.

9. The process according to claim 1, wherein the block or blocks of hydrophilic nature exhibits hydrophobic units in an amount of between 0 and 50% by weight with respect to the total mass of the block.

10. The process according to claim 1, wherein the block copolymer is prepared by a polymerization process referred to as living or controlled starting from hydrophobic and hydrophilic monomers.

11. The process according to claim 10, wherein the hydrophobic monomers are selected from the group consisting of:
vinylaromatic monomers,
diolefins, and
alkyl acrylates or methacrylates, the alkyl group of which comprising from 1 to 10 carbon atoms.

12. The process according to claim 10, wherein the hydrophilic monomers are selected from the group consisting of:
carboxylic acids comprising an ethylenic unsaturation,
neutral hydrophilic monomers, selected from the group consisting of acrylamide and its derivatives, methacrylamide, poly(ethylene glycol) methacrylate or acrylate, and
anionic hydrophilic monomers, selected from the group consisting of sodium 2-acrylamido-2-methylpropanesulphonate (AMPS), sodium styrenesulphonate and sodium vinylsulphonate.

13. The process according to claim 1, wherein the block copolymer is a diblock or triblock copolymer.

14. The process according to claim 13, wherein the block copolymer is a diblock copolymer, wherein:
the block of hydrophilic nature comprises acrylic acid (AA) units, and
the block of hydrophobic nature comprises styrene (St) units.

15. A process according to claim 10, wherein the block copolymer prepared by a process comprising the following steps:
a)—at least one ethylenically unsaturated monomer,
at least one source of free radicals, and
at least one compound of formula (I): 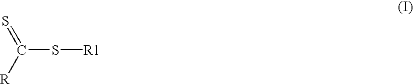
wherein:
R represents an R20-, R2R′2N- or R3- group, wherein:
R2 and R′2, which are identical or different, represent (i) an alkyl, acyl, aryl, alkene or alkyne group or (ii) an optionally aromatic, saturated or unsaturated carbonaceous ring or (iii) a saturated or unsaturated heterocycle, it being possible for these groups and rings (i), (ii) and (iii) to be substituted, and
R3 represents H, Cl, an alkyl, aryl, alkene or alkyne group, a saturated or unsaturated ring, a saturated or unsaturated heterocycle, an alkylthio, alkoxycarbonyl, aryloxycarbonyl, carboxyl, acyloxy, carbamoyl, cyano, dialkyl- or diarylphosphonato or dialkyl- or diarylphosphinato group or a polymer chain, and
R1represents (i) an optionally substituted alkyl, acyl, aryl, alkene or alkyne group or (ii) an optionally substituted or aromatic, saturated or unsaturated carbonaceous ring or (iii) an optionally substituted, saturated or unsaturated heterocycle, or a polymer chain, are brought into contact,
b) the preceding contacting operation is repeated at least once, using:
different monomers from the preceding implementation, and
in place of the precursor compound of formula (I), the polymer resulting from the preceding implementation, and
c) optionally hydrolysing the copolymer obtained.

16. The process according to claim 15, wherein the compound of formula (I) is a dithiocarbonate selected from the group consisting of the compounds of following formulae (IA), (IB) and (IC): 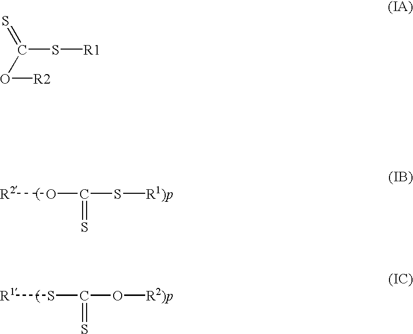
wherein:
R2 and R2′ represent (i) an alkyl, acyl, aryl, alkene or alkyne group or (ii) an optionally aromatic, saturated or unsaturated carbonaceous ring or (iii) a saturated or unsaturated heterocycle, it being possible for these groups and rings (i), (ii) and (iii) to be substituted,
R1 and R1′ represent (i) an optionally substituted alkyl, acyl, aryl, alkene or alkyne group or (ii) an optionally substituted or aromatic, saturated or unsaturated carbonaceous ring or (iii) an optionally substituted, saturated or unsaturated heterocycle, or a polymer chain,
p is between 2 and 10.

17. The process according to claim 1, starting from a blend of different copolymers or a blend of a copolymer and at least one homopolymer, the said homopolymer exhibiting a single block which is overall hydrophilic or hydrophobic.

18. A process for the manufacture of colloidal particles of controlled shape, controlled size and controlled anisotropy in aqueous dispersion from a block copolymer comprising at least one block of hydrophobic nature and at least one block of hydrophilic nature in solution in an organic solvent comprising the following steps:
step 1) the solvent is removed to obtain a solid, and
step 2) the solid obtained in step 1) is redispersed in water to obtain a dispersion of colloidal particles of controlled shape, controlled size and controlled anisotropy, said colloidal particles having a small dimension of between 10 and 100 nm.

19. A process for modifying the texture of an aqueous medium, comprising using dispersions prepared according to the process of claim 1, in an amount of at least 0.5% and of at most 5% by weight with respect to the said aqueous media to be treated.

20. The process according to claim 19, wherein the aqueous media is a paint or a latex dispersion.

21. A process for thickening a composition, comprising using dispersions prepared according to the process of claim 1, in an amount of at least 0.5% and of at most 5% by weight with respect to the said aqueous media to be treated.

22. The process according to claim 21, wherein the aqueous media is a paint or a latex dispersion.

23. A process for heat-thickening a composition, comprising using dispersions prepared by a process according to claim 1, with a concentration by weight of particles greater than 1% and less than 20%.

24. The process according to claim 23, wherein the particles have a cylindrical in shape.

25. A process for lubricating solid surfaces, comprising the step of applying onto the surface an aqueous dispersions comprising colloidal particles of controlled shape, controlled size or controlled anisotropy, at a concentration comprised between 0.5 and 5% by weight.
